(19) United States
(12) Patent Application Publication
(10) Pub. No.: US 2015/0280920 A1
(43) Pub. Date: Oct. 1, 2015

(54) SYSTEM AND METHOD FOR AUTHORIZATION

(71) Applicant: FUJITSU LIMITED, Kawasaki-shi (JP)

(72) Inventors: Motoshi SUMIOKA, Kawasaki (JP); Takeshi Ohtani, Kawasaki (JP); Nami Nagata, Kawasaki (JP); KAZUO SASAKI, Kobe (JP)

(21) Appl. No.: 14/570,380

(22) Filed: Dec. 15, 2014

(30) Foreign Application Priority Data
Mar. 31, 2014 (JP) 2014-072146

(51) Int. Cl. H04L 9/32; H04L 9/30

(52) U.S. Cl. CPC H04L 9/3247; H04L 9/30

(57) ABSTRACT

A system for authorization including a terminal that uses a service, a providing device that provides the service to the terminal, and a distribution device that distributes, to the terminal, authentication information to be used when the terminal receives the service from the providing device, the system includes: a processor; and a memory which stores a plurality of instructions, which when executed by the processor, cause the processor to execute: causing the distribution device to perform a process including receiving status information indicating a status of the terminal and a public key of the terminal transmitted from the terminal, generating a first signed document signed with a private key of the distribution device, the first signed document including authentication information in accordance with a status of the terminal indicated by the status information received and the public key of the terminal, and transmitting the first signed document to the terminal.

### CROSS-REFERENCE TO RELATED APPLICATION

This application is based upon and claims the benefit of priority of the prior Japanese Patent Application No. 2014-072146, filed on Mar. 31, 2014, the entire contents of which are incorporated herein by reference.

### FIELD

The embodiment discussed herein is related to a system for authorization, a method for authorization, and a providing device.

### BACKGROUND

When a request for a service is made from a terminal used by the user to a service provider (SP) that provides services of information, applications, and so forth through the Internet, for example, it is checked whether the user has authorization to use the service.

One of schemes used for such an authorization check is, for example, a scheme using a security assertion markup language (SAML) protocol. SAML is a standard protocol that realizes single sign-on to services scattered over the Internet. SAML is a scheme in which authentication and authorization are performed for an SP, a terminal, and an identity provider (IdP) that carries out authentication verification for a request from the SP and returns attribute information of the user. The IdP issues a ticket indicating an authentication result that guarantees the identity of the terminal. The terminal is allowed to use the service provided by the SP by giving the issued ticket to the SP. Examples of documents that disclose such a technique include Japanese Laid-open Patent Publication No. 2012-168795, Japanese Laid-open Patent Publication No. 2003-330896, Japanese Laid-open Patent Publication No. 2005-123996, and Japanese Laid-open Patent Publication No. 2013-137588.

### SUMMARY

In accordance with an aspect of the embodiments, a system for authorization including a terminal that uses a service, a providing device that provides the service to the terminal, and a distribution device that distributes, to the terminal, authentication information to be used when the terminal receives the service from the providing device, the system includes: a processor; and a memory which stores a plurality of instructions, which when executed by the processor, cause the processor to execute: causing the distribution device to perform a process including receiving status information indicating a status of the terminal and a public key of the terminal transmitted from the terminal, generating a first signed document signed with a private key of the distribution device, the first signed document including authentication information in accordance with a status of the terminal indicated by the status information received and the public key of the terminal, and transmitting the first signed document to the terminal; causing the terminal to perform a process including issuing a service request to the providing device, and making a request to the distribution device for the authentication information by transmitting the status information indicating the status of the terminal, and generating a second signed document signed with a private key of the terminal, the second signed document including provision identification information received from the providing device, and transmitting the first signed document and the second signed document to the providing device; and causing the providing device to perform a process including, in response to the service request, transmitting the provision identification information capable of uniquely identifying the second signed document to the terminal, and verifying the service request from the terminal, in accordance with a combination of a public key of the distribution device distributed in advance from the distribution device and the private key of the distribution device indicated by the first signed document received from the terminal, a combination of the public key of the terminal included in the first signed document and the private key of the terminal indicated by a signature of the second signed document, whether the provision identification information included in the second signed document is received for a first time, and the authentication information included in the first signed document.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

These and/or other aspects and advantages will become apparent and more readily appreciated from the following description of the embodiments, taken in conjunction with the accompanying drawing of which:

FIG. 1 is a block diagram illustrating a schematic configuration of a system for authorization according to this embodiment;

FIG. 2 depicts an example of a table in which the correspondence relationship between the statuses of a terminal and tickets to be issued is determined;

FIG. 3 depicts an example of a table in which the correspondence relationship between the types of tickets and providable services is determined;

FIG. 4 is a block diagram illustrating a schematic configuration of a computer that functions as a distribution device;

FIG. 5 is a block diagram illustrating a schematic configuration of a computer that functions as a terminal;

FIG. 6 is a block diagram illustrating a schematic configuration of a computer that functions as a providing device;

FIG. 7 is a flowchart illustrating an example of a service usage process;

FIG. 8 is a flowchart illustrating an example of a ticket distribution process;

FIG. 9 is a flowchart illustrating an example of a service providing process; and

FIG. 10 is a sequence diagram illustrating a method for authorization in the system for authorization.

### DESCRIPTION OF EMBODIMENT

Hereinafter, an example of an embodiment according to the disclosed techniques will be described with reference to the accompanying drawings.

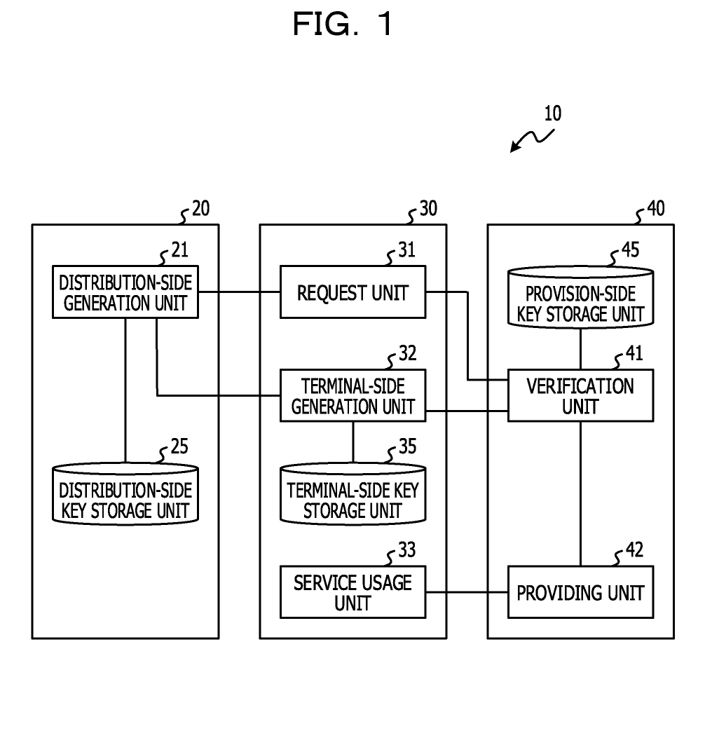

As illustrated in FIG. 1, an authorization system 10 according to this embodiment includes a terminal 30 that uses a service, a providing device 40 that provides the service to the terminal 30, and a distribution device 20 that issues a ticket to be used when the terminal 30 receives the service from the providing device 40.

The distribution device 20 includes a distribution-side generation unit 21 and a distribution-side key storage unit 25. The public key and the private key of the distribution device 20 are stored in the distribution-side key storage unit 25.

The distribution-side generation unit 21 receives a ticket distribution request that includes status information indicating a status of the terminal 30 and a public key of the terminal 30, the ticket distribution request being transmitted from the terminal 30. The status of the terminal 30 includes various states of the terminal 30, a user who uses the terminal 30, and the peripheries of the terminal 30 and the user, such as attributes of the user of the terminal 30, the location of the terminal 30, and facilities for communication that are available to the terminal 30. For example, the latitude and longitude information obtained by a position sensor of the global positioning system (GPS) or the like provided in the terminal 30, an identifier (ID) of a near field communication (NFC) device arranged at a predetermined location obtained by communication with the NFC device, or the like may be status information. Also, for example, a user ID associated with user attributes, such as the department in a company to which the user belongs, and a password managed in combination with the user ID may be used as status information.

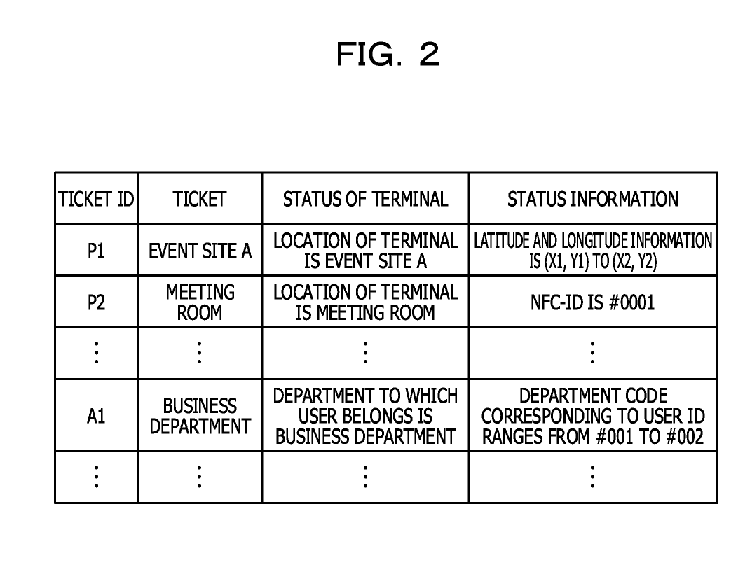

The distribution-side generation unit 21 issues a ticket that comprehensively expresses the status of the terminal 30, as authentication information indicating an authentication result for the state of the terminal 30, in order that the terminal 30 receives a service in accordance with the status of the terminal 30. Specifically, referring to a table in which the correspondence relationship between the statuses of the terminal 30 and tickets to be issued is determined in advance, for example, as depicted in FIG. 2, the distribution-side generation unit 21 issues a ticket in accordance with the status of the terminal 30 indicated by status information included in the received ticket distribution request. In an example of FIG. 2, a table is provided in which a ticket ID, a ticket indicated by the ticket ID, the status of the terminal 30 serving as conditions for issuing the ticket, and status information indicating the status of a terminal that satisfies the conditions are associated with one another.

More specifically, the distribution-side generation unit 21 issues, for example, a ticket “event site A” indicated by a ticket ID=P1 in cases where the latitude and longitude information received as status information satisfies conditions determined in the table of FIG. 2. Note that (X1, Y1) to (X2, Y2) of the table depicted in FIG. 2 indicate that conditions are satisfied in cases where (latitude X, longitude Y) indicated by the latitude and longitude information is included in a range from (X1, Y1) to (X2, Y2).

Additionally, for example, if the status information included in the ticket distribution request is a user ID and a password, the distribution-side generation unit 21 checks the authenticity of the user ID by using a separately managed table of correspondence between user IDs and passwords. The distribution-side generation unit 21 then refers to the correspondence table separately managed and including the user ID and a department code indicating the department to which a user indicated by the user ID belongs, and acquires the department code corresponding to the user ID. Further, the distribution-side generation unit 21 issues a ticket “business department” indicated by the ticket ID=A1 if the department code corresponding to the user ID satisfies conditions (#001 to #002) defined in the table of FIG. 2.

The distribution-side generation unit 21 also generates a first signed document that includes the ticket ID of an issued ticket, the public key of the terminal 30 included in the ticket distribution request, and a first random value, the first signed document being signed with the private key of the distribution device 20. Note that the first random value is an example of distribution identification information of the disclosed techniques. Although a random value is used as distribution identification information here, the distribution identification information may be a value with which the first signed document is uniquely identified. The distribution-side generation unit 21 also returns the generated first signed document to the terminal 30.

The terminal 30 includes a request unit 31, a terminal-side generation unit 32, a service usage unit 33, and a terminal-side key storage unit 35. The public key and the private key of the terminal 30 are stored in the terminal-side key storage unit 35. The terminal 30 is, for example, a personal computer (PC), a notebook PC, a tablet, a mobile phone, or the like, and is a device on which various applications are executed. The terminal 30 is equipped with the request unit 31, the terminal-side generation unit 32, and the service usage unit 33 as proxy functions that act when an application is executed on the terminal 30.

Upon receipt of a service request for provision of a service from an application that is being executed on the terminal 30, the request unit 31 generates a ticket distribution request for requesting the distribution device 20 to distribute a ticket to be used for receiving the service. As described above, the ticket distribution request includes status information indicating the status of the terminal 30 and the public key of the terminal 30 stored in the terminal-side storage unit 35. The request unit 31 causes, among status information that is acquirable, at least status information to be used for issuance of a ticket to be included in the ticket distribution request. Note that if status information to be used for issuance of a ticket, with which a service request is authorized, is unknown, all the acquirable status information may be included in a ticket distribution request. The request unit 31 transmits the generated ticket distribution request to the distribution device 20.

The request unit 31 requests the providing device 40 to provide a service by relaying a service request received from an application to the providing device 40.

The terminal-side generation unit 32 receives a first signed document returned from the distribution device 20 and a second random value (described in detail below) returned from the providing device 40 in response to a service request transmitted by the request unit 31. The terminal-side generation unit 32 generates a second signed document that includes the first random value included in the first signed document and the second random value returned from the providing device 40 and that is signed with the private key of the terminal 30. The terminal-side generation unit 32 also transmits the first signed document and the second signed document to the providing device 40.

Upon receipt of a notification of the fact that authorization to use a service is granted by the providing device 40, the service usage unit 33 notifies the application of the fact, and relays transmission and reception of data between the application and the providing device 40 so that the authorized service may be used by the application.

The providing device 40 includes a verification unit 41, a providing unit 42, and a provision-side key storage unit 45. The public key of the distribution device 20 distributed from the distribution device 20 in advance is stored in the provision-side storage unit 45.

Upon receipt of a service request transmitted from the terminal 30, the verification unit 41 returns a second random value to the terminal 30 that has transmitted that service request. Note that a second random value is an example of provision identification information of the disclosed techniques. Although a random value is used as provision identification information here, the provision identification information may be a value with which a second signed document is uniquely identified.

The verification unit 41 also receives the first signed document and the second signed document from the terminal 30, and verifies the validity of authorization to use the service requested by the terminal 30 for a ticket indicated by a ticket ID included in the first signed document.

Specifically, the verification unit 41 verifies whether the public key of the distribution device 20 stored in the provision-side key storage unit 45 and the private key of the distribution device 20 indicated by the signature of the first signed document form a valid pair. Through this verification, the verification unit 41 may confirm that the first signed document is generated by the valid distribution device 20 and, in turn, may confirm the validity of a ticket issued by the distribution device 20.

The verification unit 41 also verifies whether the public key of the terminal 30 included in the first signed document generated by the distribution device 20 and the private key of the terminal 30 indicated by the signature of the second signed document form a valid pair. Through this verification, the verification unit 41 may confirm that the terminal 30 and the distribution device 20 has an exchange to issue a ticket and that the ticket is issued to the terminal 30 requesting the service.

Using the second random value included in the second signed document, the verification unit 41 also verifies whether the second signed document is received for the first time. If the second signed document including the second random value that has already been received is received again, the verification unit 41 may determine that the second signed document received for the second time or later is one intercepted by a third party over a network. That is, through this verification, the verification unit 41 may check the validity of the terminal 30.

The verification unit 41 also verifies whether a first random value included in the first signed document matches a first random value included in the second signed document. Through this verification, the verification unit 41 may confirm that the first signed document and the second signed document are a set of signed documents generated for the same service request. Note that, by verifying whether the public key of the terminal 30 included in the first signed document and the private key of the terminal 30 indicated by the signature of the second signed document form a valid pair, it is possible to check whether the first signed document and the second signed document make a set. Here, by checking whether the first random values are included in both the documents, it may be more reliably and simply checked whether both the documents make a set.

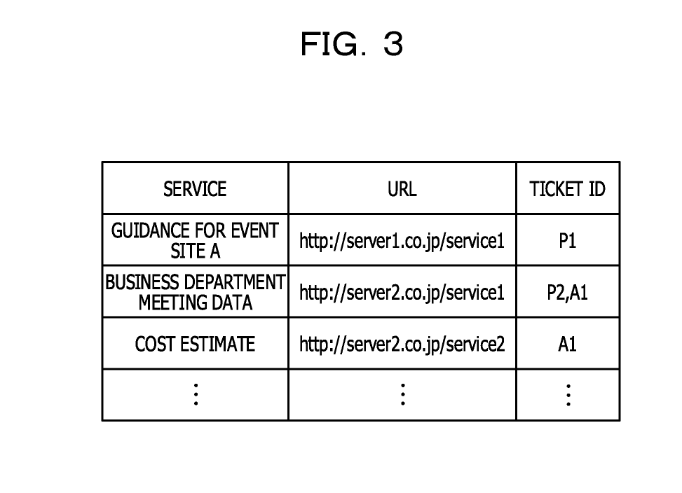

As described above, if the validity of the ticket and the terminal 30 is checked, the verification unit 41 further verifies whether the ticket is a ticket serving as authorization to use the requested service. Specifically, the verification unit 41 refers to, for example, a table in which the relationship between the types of tickets and providable services is determined in advance as depicted in FIG. 3. The verification unit 41 then verifies whether a ticket indicated by the ticket ID included in the first signed document is a ticket corresponding to the requested service. In the example of FIG. 3, the table is such that the type of service provided by the providing device 40, the uniform resource locator (URL) accessed by the terminal 30 at the time of requesting the service, and the ticket ID indicating a ticket to be used for receiving the service are associated with one another.

More specifically, for example, it is assumed that the verification unit 41 receives a first signed document including a ticket ID=P1 from the terminal 30 for a service request that makes a request for a service “Guidance for event site A”. The verification unit 41 compares a ticket ID (P1) indicating a ticket to be used for the service “Guidance for event site A” defined, for example, in the table of FIG. 3 with the received ticket ID (P1). Here, if both the ticket IDs match, the terminal 30 is authorized to use the service “Guidance for event site A”.

On the other hand, if the ticket ID included in the first signed document does not match the ticket ID (P1) indicating a ticket to be used for the service “Guidance for event site A”, the verification unit 41 does not allow the use of the service “Guidance for event site A” by the terminal 30. In this case, it is indicated that the terminal 30 does not exist at a location (event side A, latitude and longitude information (X1, Y1) to (X2, Y2), refer to FIG. 2) corresponding to the ticket indicated by the ticket ID=P1.

Additionally, the verification unit 41 may determine a plurality of tickets used for provision of a service, for example, such as a service “Business department meeting data” of the table depicted in FIG. 3. Additionally, in cases where a plurality of ticket IDs are included in the first signed document, the verification unit 41 may give authorization to use a service if any of the plurality of tickets indicated by respective ticket IDs is a ticket serving as authorization to use the requested service.

The verification unit 41 notifies the providing unit 42 of a verification result of whether to refuse or give authorization to use of the service.

When authorization to use a service with the terminal 30 is given, the providing unit 42 notifies the terminal 30 of that fact and begins to provide the service to the terminal 30. On the other hand, when authorization to use a service with the terminal 30 is refused, the providing unit 42 notifies the terminal 30 of that fact.

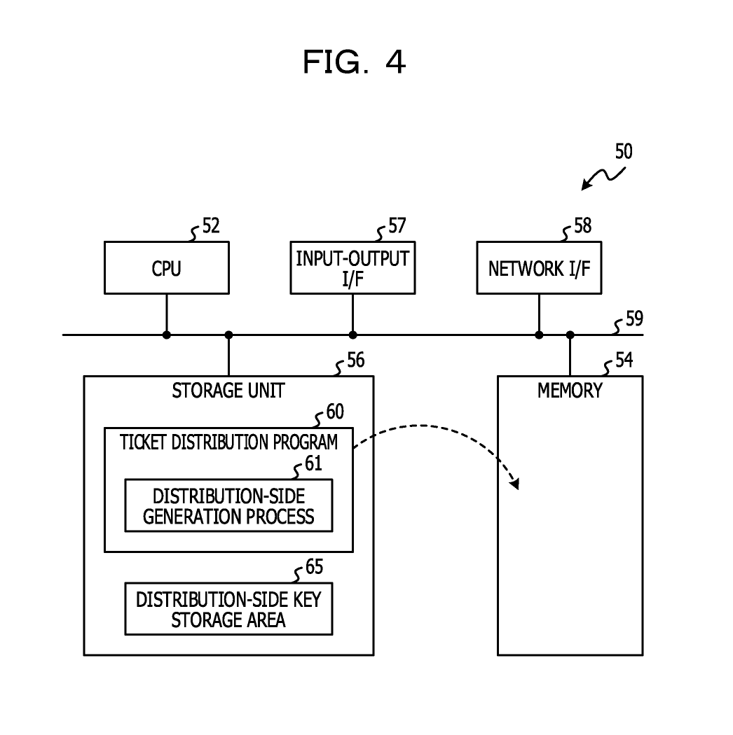

The distribution device 20 may be implemented, for example, by a computer 50 illustrated in FIG. 4. The computer 50 includes a central processing unit (CPU) 52, a memory 54, a nonvolatile storage unit 56, an input-output interface (I/F) 57, and a network I/F 58. The CPU 52, the memory 54, the storage unit 56, the input-output I/F 57, and the network I/F 58 are coupled to one another via a bus 59.

The storage unit 56 may be implemented by a hard disk drive (HDD), a solid state drive (SSD), a flash memory, or the like. A ticket distribution program 60 for causing the computer 50 to function as the distribution device 20 is stored in the storage unit 56 as a storage medium. The storage unit 56 has a distribution-side key storage area 65.

The CPU 52 reads the ticket distribution program 60 from the storage unit 56 and expands it in the memory 54 so as to sequentially execute processes included in the ticket distribution program 60. The ticket distribution program 60 includes a distribution-side generation process 61. The CPU 52 executes the distribution-side generation process 61 to operate as the distribution-side generation unit 21 illustrated in FIG. 1. The distribution-side key storage area 65 functions as the distribution-side key storage unit 25 illustrated in FIG. 1. As a result, the computer 50 executing the ticket distribution program 60 functions as the distribution device 20.

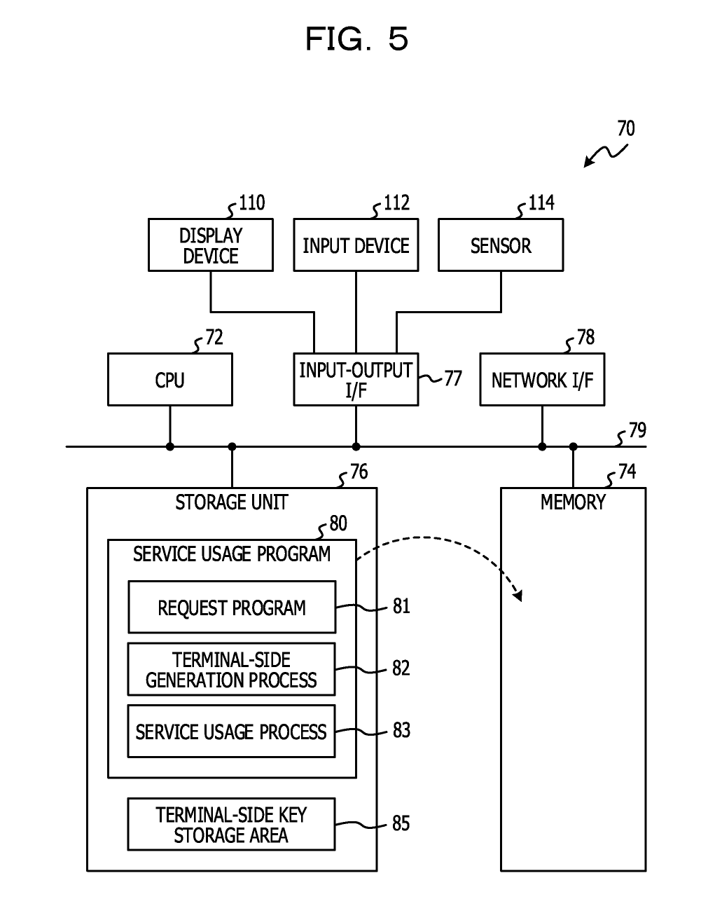

The terminal 30 may be implemented, for example, by a computer 70 illustrated in FIG. 5. The computer 70 includes a CPU 72, a memory 74, a nonvolatile storage unit 76, an input-output I/F 77, and a network I/F 78. The CPU 72, the memory 74, the storage unit 76, the input-output I/F 77, and the network I/F 78 are coupled to one another via a bus 79. A display device 110, an input device 112, and a sensor 114 are coupled to the input-and-output I/F 77. The sensor 114 is a component for acquiring the status information of the terminal 30. Any sensor, for example, a GPS, an NFC reading device, an illuminance sensor, or the like is applicable as the sensor 114, and a plurality of sensors may also be included in the sensor 114. Note that status information may be acquired from an external device coupled to the network I/F 78 and provided in a network, or the like.

The storage unit 76 may be implemented by an HDD, an SSD, a flash memory, or the like. A service usage program 80 for causing the computer 70 to function as the terminal 30 is stored in the storage unit 76 as a storage medium. The storage unit 76 also has a terminal-side key storage area 85.

The CPU 72 reads the ticket distribution program 80 from the storage unit 76 and expands it in the memory 74 so as to sequentially execute processes included in the service usage program 80. The service usage program 80 includes a request process 81, a terminal-side generation process 82, and a service usage process 83. The CPU 72 executes the request process 81 to operate as the request unit 31 illustrated in FIG. 1. The CPU 72 executes the terminal-side generation process 82 to operate as the terminal-side generation unit 32 illustrated in FIG. 1. The CPU 72 executes the service usage program 83 to operate as the service usage unit 33 illustrated in FIG. 1. Additionally, the terminal-side key storage area 85 functions as the terminal-side key storage unit 35 illustrated in FIG. 1. As a result, the computer 70 executing the service usage program 80 functions as the terminal 30.

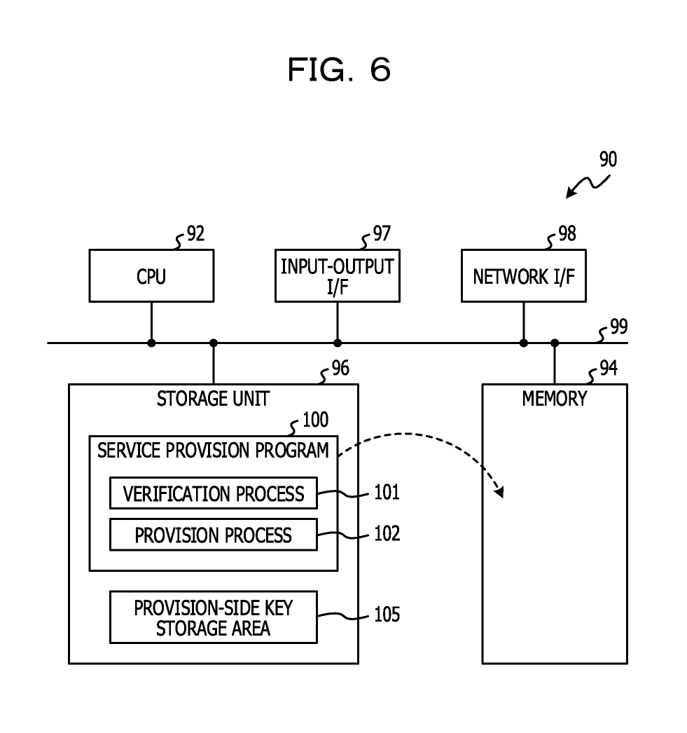

The providing device 40 may be implemented, for example, by a computer 90 illustrated in FIG. 6. The computer 90 includes a CPU 92, a memory 94, a nonvolatile storage unit 96, an input-output I/F 97, and a network I/F 98. The CPU 92, the memory 94, the storage unit 96, the input-output I/F 97, and the network I/F 98 are coupled to one another via a bus 99.

The storage unit 96 may be implemented by an HDD, an SSD, a flash memory, or the like. A service provision program 100 for causing the computer 90 to function as the providing device 40 is stored in the storage unit 96 as a storage medium. The storage unit 96 also has a provision-side key storage area 105.

The CPU 92 reads the service provision program 100 from the storage unit 96 and expands it in the memory 94 so as to sequentially execute processes included in the service provision program 100. The service provision program 100 includes a verification process 101 and a provision process 102. The CPU 92 executes the verification process 101 to operate as the verification unit 41 illustrated in FIG. 1. The CPU 92 executes the provision process 102 to operate as the providing unit 42 illustrated in FIG. 1. The provision-side key storage area 105 functions as the provision-side key storage unit 45 illustrated in FIG. 1. As a result, the computer 90 executing the service provision program 100 functions as the providing device 40.

Note that the distribution device 20, the terminal 30, and the providing device 40 each may be implemented, for example, by a semiconductor integrated circuit, more particularly an application specific integrated circuit (ASIC) or the like.

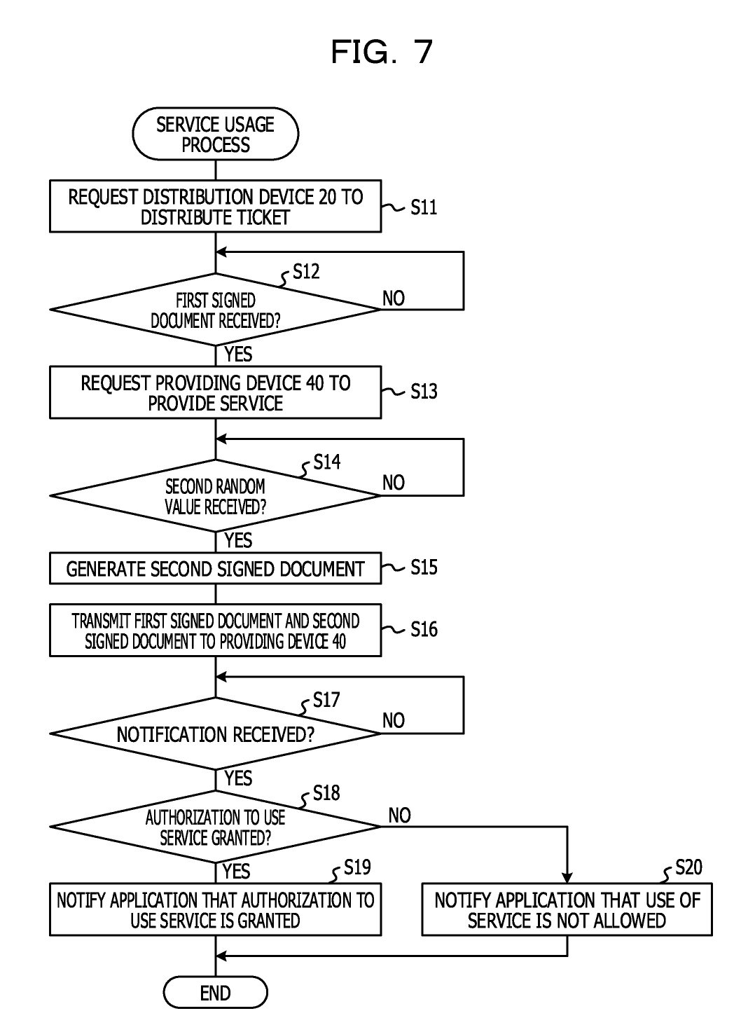

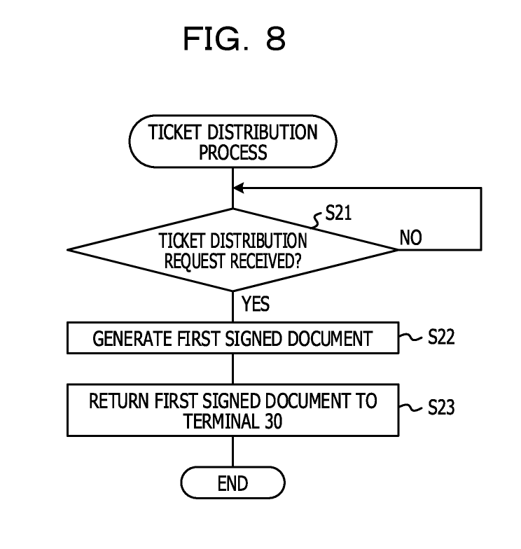

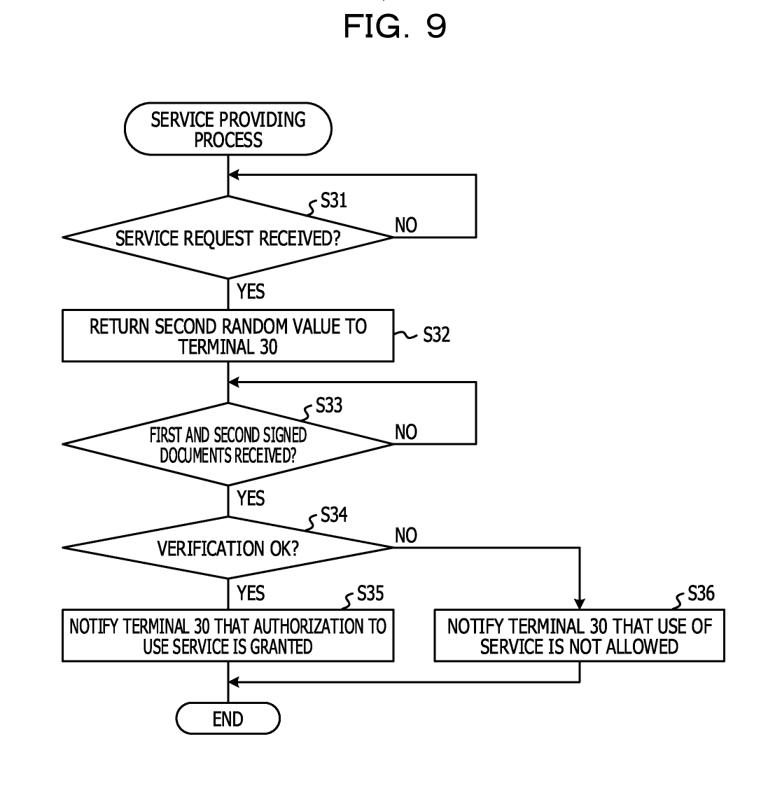

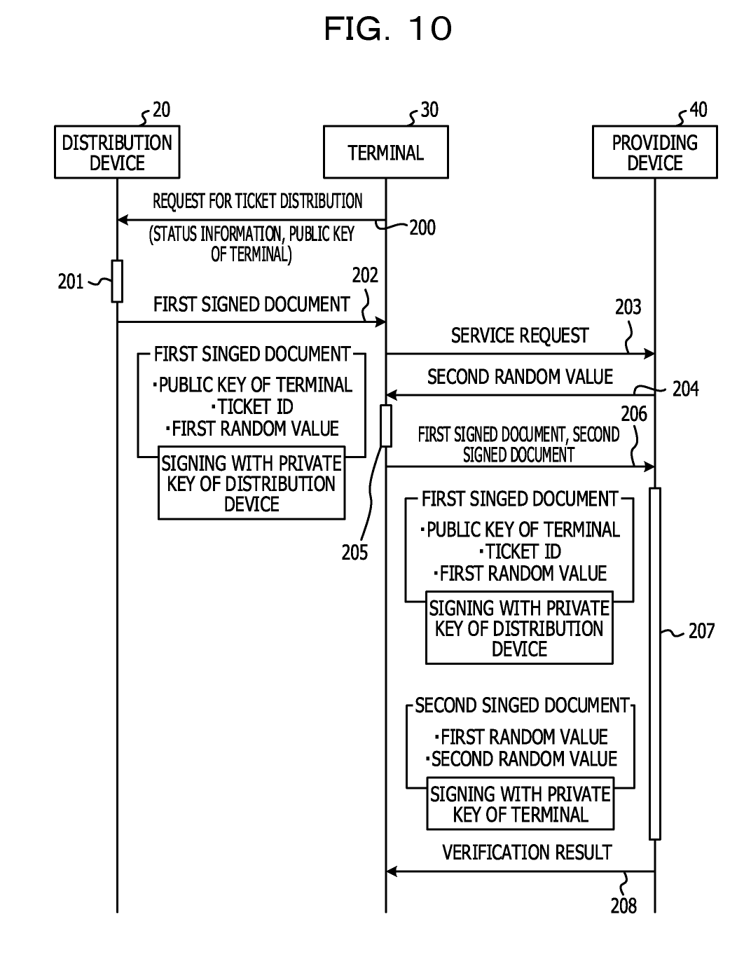

Next, operations of the authorization system 10 according to this embodiment will be described. When a service request occurs in an application being executed in the terminal 30, a service usage process illustrated in FIG. 7 is performed in the terminal 30. In the distribution device 20, after activation of the distribution device 20, a ticket distribution process illustrated in FIG. 8 is repeatedly performed. In the providing device 40, after activation of the providing device 40, a service providing process illustrated in FIG. 9 is repeatedly performed. With reference to a sequence diagram of FIG. 10 illustrating a method for authentication in the authorization system 10 performed by executing each process, each process will be described in detail below.

First, at step S11 of the service usage process (FIG. 7) performed in the terminal 30, the request unit 31 receives a service request that has occurred in the application, and acquires status information to be used for issuance of a ticket, with which a service request is authorized. The request unit 31 also reads the public key of the terminal 30 from the terminal-side key storage unit 35. The request unit 31 generates a ticket distribution request including status information and the public key of the terminal 30 and transmits the request to the distribution device 20 (200 in FIG. 10). Note that if status information to be used for issuance of a ticket, with which a service request is authorized, is unknown, all the acquirable status information may be included in a ticket distribution request.

Next, at step S12, it is determined whether the terminal-side generation unit 32 has received the first signed document returned from the distribution device 20. Determination of this step is repeated until the first signed document is received.

Here, at step S21 of the ticket distribution process (FIG. 8) performed in the distribution device 20, it is determined whether the distribution-side generation unit 21 receives a ticket distribution request transmitted from the terminal 30. If no ticket distribution request is received, the distribution-side generation unit 21 repeats determination of this step until a ticket distribution request is received. Upon receipt of a ticket distribution request, the process proceeds to step S22.

At step S22, referring to a table in which the correspondence relationship between the statuses of the terminal 30 and tickets to be issued are determined in advance, for example, as illustrated in FIG. 2, the distribution-side generation unit 21 issues a ticket in accordance with the status of the terminal 30 indicated by status information included in the received ticket distribution request. The distribution-side generation unit 21 then generates a document including the ticket ID of the issued ticket, the public key of the terminal 30 included in the ticket distribution request, and the first random value. The distribution-side generation unit 21 then reads the public key of the distribution device 20 from the distribution-side key storage unit 25 and signs the generated document with the public key of the distribution device 20, thereby generating the first signed document (201 in FIG. 10).

Next, at step S23, the distribution-side generation unit 21 returns the generated first signed document to the terminal 30 (202 in FIG. 10).

As a result, the determination at step S12 of the service usage process illustrated in FIG. 7 is affirmative, and the process proceeds to step S13. At step S13, the providing device 40 is requested to provide a service by relay of the service request received from the application to the providing device 40 (203 in FIG. 10).

Next, at step S14, it is determined whether the terminal-side generation unit 32 has received the second random value returned from the providing device 40. The determination of this step is repeated until the second random value is received.

Here, at step S31 of the service providing process (FIG. 9) performed in the providing device 40, the verification unit 41 determines whether the service request transmitted from the terminal 30 has been received. If no service request has been received, the determination of this step is repeated until the service request is received. Upon receipt of the service request, the process proceeds to step S32.

At step S32, the verification unit 41 returns the second random value to the terminal 30 that has transmitted the service request (204 in FIG. 10).

As a result, the determination at step S14 of the service usage process illustrated in FIG. 7 is affirmative, and the process proceeds to step S15. Meanwhile, the service providing process illustrated in FIG. 9 proceeds to step S33, where it is determined whether the verification unit 41 has received the first signed document and the second signed document transmitted from the terminal 30. The determination of this step is repeated until the first signed document and the second signed document are received.

At step S15 of the service usage process illustrated in FIG. 7, the terminal-side generation unit 32 generates a document including the first random value included in the first signed document received at the step S12 mentioned above and the second random value received at step S14 mentioned above. Then, the terminal-side generation unit 32 reads the private key of the terminal 30 from the terminal-side key storage unit 35 and signs the generated document with the private key of the terminal 30, thereby generating the second signed document (205 in FIG. 10).

Next, at step S16, the terminal-side generation unit 32 transmits the first signed document received at step S12 mentioned above and the second signed document generated at step S15 mentioned above to the providing device 40 (206 in FIG. 10).

As a result, the determination at step S33 of the service providing process illustrated in FIG. 9 is affirmative, and the process proceeds to step S34. Meanwhile, the service usage process illustrated in FIG. 7 proceeds to step S17, where it is determined whether the service usage unit 33 has received a notification on the use of a service from the providing device 40. The determination of this step is repeated until the notification is received.

At step S34 of the service providing process illustrated in FIG. 9, the verification unit 41 verifies the validity of the ticket indicated by the ticket ID included in the first signed document and the validity of the terminal 30 requesting the service, using the received first signed document and second signed document. The verification unit 41 further verifies whether the ticket indicated by the ticket ID included in the first signed document is a ticket serving as authorization to use the requested service. The verification unit 41 determines whether to give authorization to use the service. If authorization is given, the process proceeds to step S35, and if the use of a service is not allowed, the process proceeds to step S36 (207 in FIG. 10).

At step S35, the verification unit 41 notifies the providing unit 42 of a verification result that authorization to use the service is given. The providing unit 42 notifies the terminal 30, which has transmitted a service request, that the use of the service will be started, and starts providing the service to the terminal 30 (208 in FIG. 10).

On the other hand, at step S36, the verification unit 41 notifies the providing unit 42 of a verification result that the use of the service is not allowed. The providing unit 42 notifies the terminal 30, which has transmitted the service request, that the use of the service is not allowed (208 in FIG. 10).

As a result, the determination at step S17 of the service usage process illustrated in FIG. 7 is affirmative, and the process proceeds to step S18. At step S18, the service usage unit 33 determines whether the notification received by the service usage unit 33 is one to the effect that the use of the service will be started. If the notification is one to the effect that the use of the service will be started, the process proceeds to step S19, whereas if the notification is one to the effect that the use of the service is not allowed, the process proceeds to step S20.

At step S19, the service usage unit 33 notifies the application that the use of the service will be started and relays transmission and reception of data between the application and the providing device 40 so that the authorized service is used by the application.

On the other hand, at step S20, the service usage unit 33 makes a report to the user, for example, by displaying, on the display device 110, a message indicating that the use of the service is not allowed, and then the service usage process ends.

Note that processing of a service request made from the terminal 30 to the providing device 40 at step S13 of the service usage process illustrated in FIG. 7 may be performed before or at the same time as the ticket distribution request to the distribution device 20 at step S11. The processing may be performed before it is determined at step S12 that the first signed document has been received.

As described above, with the authorization system 10 according to this embodiment, the distribution device 20 issues a ticket in accordance with the status information received from the terminal 30. The distribution device 20 then distributes, to the terminal 30, the first signed document that includes the ticket ID indicating the issued ticket and the public key of the terminal 30 and that is signed with the private key of the distribution device 20. The terminal 30 generates the second signed document that includes the second random value transmitted from the providing device 40 and that is signed with the private key of the terminal 30, and transmits the second signed document, together with the first signed document distributed from the distribution device 20, to the providing device 40. In the providing device 40, a combination of the public key of the distribution device 20 distributed in advance from the distribution device 20 and the private key of the distribution device 20 indicated by the signature of the first signed document is verified. A combination of the public key of the terminal 30 included in the first signed document and the private key of the terminal 30 indicated by the signature of the second signed document is also verified. Further, it is verified whether the second random value included in the second signed document is received for the first time. As a result, it is possible to inhibit unauthorized use of a ticket that is distributed among unspecified users under a specific situation and that serves as authorization to use a service request.

More specifically, description will be given of cases where unauthorized use of a ticket is inhibited in each of situations in which the ticket is likely to be intercepted.

In a situation where the first signed document is transmitted from the distribution device 20 to the terminal 30 (202 in FIG. 10), it is assumed that the first signed document including a ticket ID is intercepted by a third party. In this case, the third party does not hold a private key paired with the public key of the terminal 30 included in the first signed document. Even if the third party acquires the second random value from the providing device 40, the third party does not have a private key of the terminal 30 to be used for signing. Consequently, it is impossible to generate a valid second signed document. If the providing device 40 receives the second signed document without valid signing, the providing device 40 may refuse the service request. Accordingly, even if the first signed document is intercepted, unauthorized use thereof may be inhibited.

Additionally, in a situation where the first signed document and the second signed document are transmitted from the terminal 30 to the providing device 40 (206 in FIG. 10), it is assumed the first signed document and the second signed document are intercepted by a third party. In this case, it is difficult to assume that both the documents intercepted by the third party arrive at the providing device 40 before both the documents transmitted from the terminal 30, which is a valid sender, would arrive at the providing device 40. This is because the third party who has intercepted both the documents is considered to perform processing such as rewriting of identification information (IP address or the like) of the terminal 30 in order to receive a reply from the providing device 40. That is, when the second signed document including the second random value already received is transmitted, the providing device 40 is able to determine, based on the second random value, that this access is made by the third party, and may refuse such a service request. Accordingly, even if the first signed document and the second signed document are intercepted, unauthorized use thereof may be inhibited.

Moreover, it is assumed that the private key of the terminal 30 is flown to the third party and the first signed document is intercepted. In this case, the third party is able to generate a valid second signed document by acquiring the second random value from the providing device 40. In this case, the first random value included in the first signed document may be specified, and the providing device 40 may be notified to invalidate the first signed document. As a result, the providing device 40 may refuse receipt of the invalidated first signed document. Additionally, the first random value is information with which the first signed document is uniquely identifiable. Therefore, when a ticket distribution request is made again from the valid terminal 30, a first signed document including a first random value that is different from that included in the intercepted document is distributed. Thus, no service request from the valid terminal 30 is inhibited.

As described above, with the system for authorization according to this embodiment, a measure is taken against ticket interception. Even in the case where a secure network path is not built among the distribution device 20, the terminal 30, and the providing device 40, it is possible to distribute a ticket. Even in the case where a storage for keeping a ticket is not a secure storage, it is possible to inhibit the flown ticket from unauthorized use. This enables a ticket to be stored for a long time. If the public key of the distribution device 20 is distributed in advance from the distribution device 20 to the providing device 40, it is unnecessary to take an exchange between the distribution device 20 and the providing device 40 during authorization for use of a service. Thus, the distribution device 20 and the providing device 40 may be built as a system in which they are separated in terms of networking.

The system for authorization according to this embodiment is applied, for example, to the case of a user who is present at a specific location such as an event site to perform management, such as user registration. Without authentication of the origin of the terminal 30, a service suitable for a specific location where the user is present may be provided.

Additionally, as the situation of the terminal 30 demands, that is, as a ticket issued with the distribution device 30 demands, the network connected to the terminal 30 may be changed, or the terminal 30 may be separated from the network. For example, a service request is made using a ticket indicating that the user is present in the company to serve as authorization to use a service. This enables a “company secret” file stored in the providing device 40 to be accessed. In contrast, a ticket indicating that the user is present in the company is not issued to the user outside the company. The user outside the company is separated from the network and thus is unable to access the “company secret” file. In such a manner, as the situation of the terminal 30 demands, the network configuration may be dynamically built.

It is to be noted that although description has been given of the case where the first random value is included in the first signed document, the validity of the ticket and the terminal 30 is verifiable without the first random value. Thus, the first random value may be omitted. However, using the first random value enables the first signed document to be invalidated on a document basis, as described above. This may restrict the range to which the influence of refusal of service usage extends to a demanded range. Additionally, using the first random value, it may be more reliably and simply checked whether the first singed document and the second signed document make a set, as described above.

In the foregoing embodiment, the form in which the ticket distribution program 60, the service usage program 80, and the service provision program 100 are stored in advance in the storage unit 56, the storage unit 76, and the storage unit 96, respectively, has been described, but these programs are not particularly limited. These programs may be provided in the form in which they are recorded in a storage medium such as a compact disc (CD)-read-only memory (ROM), a digital video disc (DVD)-ROM, or a universal serial bus (USB) memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A system for authorization including a terminal that uses a service, a providing device that provides the service to the terminal, and a distribution device that distributes, to the terminal, authentication information to be used when the terminal receives the service from the providing device, the system comprising:
a processor; and
a memory which stores a plurality of instructions, which when executed by the processor, cause the processor to execute:
causing the distribution device to perform a process including receiving status information indicating a status of the terminal and a public key of the terminal transmitted from the terminal, generating a first signed document signed with a private key of the distribution device, the first signed document including authentication information in accordance with a status of the terminal indicated by the status information received and the public key of the terminal, and transmitting the first signed document to the terminal;
causing the terminal to perform a process including
issuing a service request to the providing device, and making a request to the distribution device for the authentication information by transmitting the status information indicating the status of the terminal, and
generating a second signed document signed with a private key of the terminal, the second signed document including provision identification information received from the providing device, and transmitting the first signed document and the second signed document to the providing device; and
causing the providing device to perform a process including, in response to the service request, transmitting the provision identification information capable of uniquely identifying the second signed document to the terminal, and verifying the service request from the terminal, in accordance with a combination of a public key of the distribution device distributed in advance from the distribution device and the private key of the distribution device indicated by the first signed document received from the terminal, a combination of the public key of the terminal included in the first signed document and the private key of the terminal indicated by a signature of the second signed document, whether the provision identification information included in the second signed document is received for a first time, and the authentication information included in the first signed document.

2. The system according to claim 1,
wherein, in the causing the distribution device to perform the process, distribution identification information capable of uniquely identifying the first signed document is caused to be further included in the first signed document, and
wherein, in the causing the terminal to perform the process, the distribution identification information included in the first signed document is caused to be further included in the second signed document.

3. A method for authorization, the method being performed by a system for authorization including a terminal that uses a service, a providing device that provides the service to the terminal, and a distribution device that distributes, to the terminal, authentication information to be used when the terminal receives the service from the providing device, the method comprising:
causing, by a computer processor, the distribution device to perform a process including receiving status information indicating a status of the terminal and a public key of the terminal transmitted from the terminal, generating a first signed document signed with a private key of the distribution device, the first signed document including authentication information in accordance with a status of the terminal indicated by the status information received and the public key of the terminal, and transmitting the first signed document to the terminal;
causing the terminal to perform a process including
issuing a service request to the providing device, and making a request to the distribution device for the authentication information by transmitting the status information indicating the status of the terminal, and
generating a second signed document signed with a private key of the terminal, the second signed document including provision identification information received from the providing device, and transmitting the first signed document and the second signed document to the providing device; and
causing the providing device to perform a process including, in response to the service request, transmitting the provision identification information capable of uniquely identifying the second signed document to the terminal, and verifying the service request from the terminal, in accordance with a combination of a public key of the distribution device distributed in advance from the distribution device and the private key of the distribution device indicated by the first signed document received from the terminal, a combination of the public key of the terminal included in the first signed document and the private key of the terminal indicated by a signature of the second signed document, whether the provision identification information included in the second signed document is received for a first time, and the authentication information included in the first signed document.

4. The method according to claim 3,
wherein, in the causing the distribution device to perform the process, distribution identification information capable of uniquely identifying the first signed document is caused to be further included in the first signed document, and
wherein, in the causing the terminal to perform the process, the distribution identification information included in the first signed document is caused to be further included in the second signed document.

5. A providing device that provides a service to the terminal that uses the service, the providing device being included, together with the terminal, and a distribution device that distributes, to the terminal, authentication information to be used when the terminal receives the service, in a system for authorization, the providing device comprising:
a processor; and
a memory which stores a plurality of instructions, which when executed by the processor, cause the processor to execute:
receiving, from the terminal, a first signed document generated by the distribution device, the first signed document being signed with a private key of the distribution device and including authentication information in accordance with a status of the terminal indicated by the received status information, and a second signed document generated by the terminal, the second signed document signed with a private key of the terminal and including provision identification information capable of uniquely identifying the second signed document returned in response to a service request of the terminal; and
verifying the service request from the terminal, in accordance with a combination of a public key of the distribution device distributed in advance from the distribution device and a private key of the distribution device indicated by a signature of the first signed document received from the terminal, a combination of the public key of the terminal included in the first signed document and the private key of the terminal indicated by a signature of the second signed document, whether the provision identification information included in the second signed document is received for a first time, and the authentication information included in the first signed document.
